(19) United States
(12) Patent Application Publication
(10) Pub. No.: US 2007/0039495 A1
(43) Pub. Date: Feb. 22, 2007

(54) Feeding device, recording system, and feeding method

(75) Inventor: Takashi Sakamoto, Kyoto (JP)

Correspondence Address: MCDERMOTT WILL & EMERY LLP, 600 13TH STREET, N.W., WASHINGTON, DC, 20005-3096, US

(73) Assignee: DAINIPPON SCREEN MFG. CO., LTD.

(21) Appl. No.: 11/496,587

(22) Filed: Aug. 1, 2006

(30) Foreign Application Priority Data
Aug. 1, 2005 (JP) JP2005-222821

(51) Int. Cl. B41F 13/54

(52) U.S. Cl. 101/228

(57) ABSTRACT

A feeding device that feeds a rolled paper to a printing apparatus is provided with a feeding mechanism, a tension measuring mechanism, and an outlet side guide roller. The feeding mechanism feeds a predetermined amount of the rolled paper in a forward direction so that slack is provided downstream of the outlet side guide roller. Thereafter, positioning is executed while recovering the rolled paper by feeding it in the opposite direction. The feeding mechanism further includes an inlet feeding mechanism and an outlet feeding mechanism. The inlet feeding mechanism performs a backward feeding of a small amount of the rolled paper, and the outlet feeding mechanism performs a forward feeding of a small amount of the rolled paper, in order to increase tension by pulling the rolled paper from both sides. With the feeding mechanism stopped, the tension measuring mechanism measures the tension, and repeats the process for increasing tension until it is not less than a predetermined value. This permits adequate adjustment of the initial state of a long recording medium when loading it, and prevents the recording medium from being consumed in vain due to a preliminary feeding and breakage.

### BACKGROUND OF THE INVENTION

1. Field of the Invention

The present invention is generally directed toward a technique of feeding a long recording medium and is more particularly related to a technique of appropriately loading a long recording medium.

2. Description of the Background Art

When a recording device is used to record information on a long recording medium (e.g., a film, a magnetic tape, or a printing paper), it is necessary to feed the recording medium to the recording device by a feeding device. In order to achieve an accurate recording, it is required to maintain suitable positional accuracy of the recording medium with respect to the recording device. The positional accuracy of the recording medium with respect to the recording device depends largely on the feeding accuracy of the recording medium fed by the feeding device. It is therefore necessary to improve the feeding accuracy of the feeding device.

In order to improve the feeding accuracy, it is preferable to perform high-accuracy positioning in a lateral direction (namely a direction orthogonal to a direction of feeding) before starting feeding. It is also preferable to provide suitable tension on the recording medium under feeding, in order to suppress a deviation of the fed recording medium.

On the other hand, a recording medium loaded by an operator, for example, may be meandered laterally, or not under predetermined tension. Therefore, if the feeding device starts to feed the recording medium as it is, the feeding accuracy is lowered.

Conventionally, there have been proposed techniques of adjusting a recording medium loaded by an operator to an appropriate loading state (the initial state). For example, in a way, feeding rollers for pinching and feeding a recording medium are disposed on an inlet side and an outlet side of a recording device, respectively, and the feeding speed of the feeding roller on the outlet side is set higher than that of the feeding roller on the inlet side. When a preliminary feeding of the loaded recording medium is performed in this state, tension is gradually provided on the recording medium by a speed difference, and the tension will reach a predetermined value. If a guide roller (a lateral positioning member) is disposed on the inlet side, the preliminary feeding also enables the lateral positioning of the recording medium.

Nevertheless, this method wastes the recording medium by the amount of that used in the preliminary feeding. To overcome this disadvantage, for example, Japanese Patent Application Laid-Open No. 2000-127352 describes a technique of providing tension on a recording medium while suppressing the preliminary feeding.

It is however difficult for the technique of this publication to control tension with high accuracy. That is, pulling the recording medium from both of the inlet and outlet sides causes a rapid increase in tension provided on the recording medium, making it difficult to control the timing for stopping the feeding roller on the inlet side and that on the outlet side. In some cases, the recording medium may be broken.

On the other hand, the lateral positioning by the guide roller requires at least a preliminary feeding during the time the recording medium passes through the guide roller on the inlet side and reaches the outlet side. This still involves a waste of the recording medium due to the preliminary feeding.

### SUMMARY OF THE INVENTION

The present invention is generally directed toward a technique of feeding a long recording medium and is more particularly directed to a technique of appropriately loading a long recording medium.

To this end, in accordance with one preferred embodiment, there is provided a feeding device that feeds a long recording medium in a forward direction with respect to a recording device, including: a measuring element that measures tension on the recording medium in the recording device; a tensioning element that stepwise increases little by little tension on the recording medium in the recording device; and a control element that directs the measuring element to measure tension on the recording medium every time the tensioning element produces an increase in tension, and that directs the tensioning element to further increase the tension on the recording medium until the tension on the recording medium measured by the measuring element is not less than a predetermined value.

Thus, the feeding device is adapted to measure tension on the recording medium every time the tension is increased, and further increase the tension on the recording medium until the measured value of the tension thereon is not less than the predetermined value. This enables the tension to be controlled with higher accuracy than the case of controlling the tension while continuously increasing it. For example, the breakage of the recording medium is avoidable.

Preferably, the feeding device further includes: an outlet feeding element that feeds the recording medium in the forward direction on an outlet side of the recording device; and a first pinching element that pinches the recording medium on an inlet side of the recording device. The tensioning element increases little by little tension on the recording medium by controlling the outlet feeding element so as to feed a small amount of the recording medium, while allowing the first pinching element to pinch and stop the recording medium.

Preferably, the feeding device further includes: an inlet feeding element that feeds the recording medium in an opposite direction of the forward direction on the inlet side of the recording device; and a second pinching element that pinches the recording medium on the outlet side of the recording device. The tensioning element gradually increases little by little tension on the recording medium by controlling the inlet feeding element so as to feed a small amount of the recording medium in the opposite direction, while allowing the second pinching element to pinch and stop the recording medium.

With the above construction, tension is increased with one end of the recording medium stopped. It is therefore unnecessary to perform any auxiliary run of the recording medium until it is under predetermined tension. This suppresses a waste of the recording medium.

Preferably, the feeding device further includes: an inlet feeding element that feeds the recording medium in an opposite direction of the forward direction on the inlet side of the recording device; and an outlet feeding element that feeds the recording medium in the forward direction on the outlet side of the recording device. The tensioning element increases little by little tension on the recording medium by controlling the inlet feeding element so as to feed a small amount of the recording medium in the opposite direction, and controlling the outlet feeding element so as to feed a small amount of the recording medium in the forward direction.

Since it is adapted to increase tension by pulling the recording medium from both ends thereof, it is unnecessary to perform any auxiliary run of the recording medium until it is under predetermined tension. This suppresses a waste of the recording medium.

In accordance with another preferred embodiment of the present invention, there is provided a feeding device that feeds a long recording medium in a forward direction with respect to a recording device, including: (i) a feeding element that feeds the recording medium in the forward direction and in an opposite direction of the forward direction; (ii) an inlet side guiding element that is disposed on an inlet side of the recording device, and guides a position of the recording medium in a lateral direction orthogonal to the forward direction, to a predetermined position; (iii) an outlet side guiding element that is disposed on an outlet side of the recording device, and guides a position of the recording medium in the lateral direction, to substantially the same position as the inlet side guiding element; (iv) a storing element that is disposed on a downstream side with respect to the forward direction of the outlet side guiding element, and stores in advance the recording medium of not less than a predetermined amount feedable in the opposite direction; and (iv) a control element that controls a feed of the recording medium performed by the feeding element. The control element controls so that at least part of the recording medium guided by the outlet side guiding element to the predetermined position in the lateral direction is fed to the inlet side guide element, by allowing the recording medium stored in the storing element by the storing element to be fed in the opposite direction.

This eliminates the necessity for a forward auxiliary run at the time of lateral positioning, and hence a waste of the recording medium is avoidable.

In accordance with a still further aspect of the present invention, there is provided a recording system that records information in a long recording medium, including: a recording device that records information on the recording medium; and a feeding device that feeds the recording medium in a forward direction to the recording device. The feeding device is provided with (i) a measuring element that measures tension on the recording medium in the recording device; (ii) a tensioning element that stepwise increases little by little tension on the recording medium in the recording device; and (iii) a control element that directs the measuring element to measure tension on the recording medium every time the tensioning element produces an increase in tension, and that directs the tensioning element to further increase the tension on the recording medium until the tension on the recording medium measured by the measuring element is not less than a predetermined value.

In accordance with a still further aspect of the present invention, there is provided a feeding method for feeding a long recording medium in a forward direction to a recording device, including the steps of: (i) a measuring step of measuring tension on the recording medium in the recording device; (ii) a tensioning step of stepwise increasing little by little tension on the recording medium in the recording device; and (iii) a control step of repeating the tensioning step until the tension on the recording medium is not less than a predetermined value, while allowing for measurement of tension on the recording medium in the measuring step every time the tensioning step is executed to increase the tension on the recording medium.

Therefore, an object of the present invention is to adequately adjust the initial state of a long recording medium at the time of its loading, and also prevent the recording medium from being consumed in vain due to a preliminary feeding and breakage.

These and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a block diagram illustrating a recording system in one preferred embodiment of the present invention;

FIG. 2 is a flow chart illustrating mainly the operation of a feeding device in the recording system;

FIG. 3 is a flow chart illustrating the operation of a positioning process in the feeding device; and

FIG. 4 is a flow chart illustrating the operation of a tensioning process in the feeding device.

### DESCRIPTION OF THE PREFERRED EMBODIMENTS

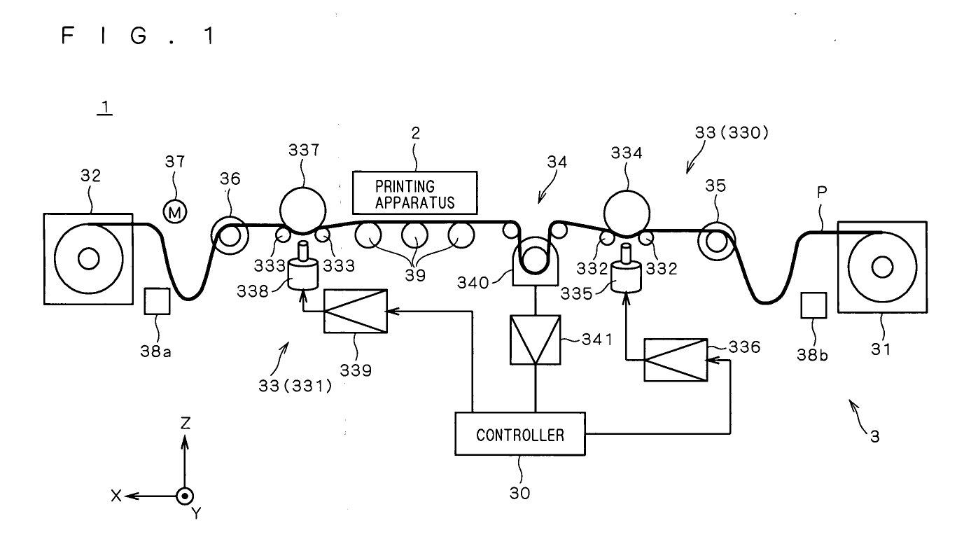

FIG. 1 is a block diagram illustrating a recording system 1 according to one preferred embodiment of the present invention. In FIG. 1, for convenience of illustration and description, it is defined that the Z-axis is the vertical direction, the Y-axis is a direction orthogonal to a direction of feeding of a rolled paper P (namely the lateral direction), and the X-axis is a direction orthogonal to the Y-axis. These are for the purpose of understanding the positional relationships, and are not to be construed as limiting later-described directions. In the following, the direction of feeding of the rolled paper P is a direction orthogonal to the Y-axis, but it is not necessarily a direction along the X-axis.

The recording system 1 consists of a printing apparatus 2 that prints image (character) information on the rolled paper P, which is a long recording medium (a recording medium called “web”), and a feeding device 3 that feeds the rolled paper P with respect to the printing apparatus 2. In the recording system 1 of the preferred embodiment, description will be made with the printing apparatus 2 as a recording device. Therefore, in the present preferred embodiment, information recorded on the recording medium is image (character) information, and the long recording medium is the rolled paper P. Without limiting to this, the recording system 1 is applicable to an exposure system using a film as a recording medium, a recording device using a magnetic tape as a recording medium, and the like.

The feeding device 3 has a controller 30, a supplying unit 31, a winding unit 32, and a feeding mechanism 33, and feeds the rolled paper P to the printing apparatus 2, as above described.

The controller 30 consists mainly of a CPU and a storage device (which are not shown). The CPU operates according to a predetermined program stored in the storage device. Thus, the controller 30 has the function as a general microcomputer. The controller 30 uses control signals to control other mechanisms provided in the feeding device 3.

An unused rolled paper P supplied to the printing apparatus 2 is set to the supplying unit 31. In the feeding device 3, the rolled paper P is fed by pulling it from the supplying unit 31.

The winding unit 32 winds mainly a recorded (printed) rolled paper P. That is, the rolled paper P with image information printed by the printing apparatus 2 is wound by the winding unit 32, and then carried out of the recording system 1.

It will be seen from FIG. 1 that the rolled paper P is fed not only in a direction along the X-axis, but also a direction along the Z-axis. In the following description, with regard to the feeding direction of the rolled paper P, in some cases, the direction of feeding toward the supplying unit 31 is called “upstream,” and that toward the winding unit 32 is called “downstream.” Specifically, when the rolled paper P is fed in a forward direction, the rolled paper P is fed from upstream to downstream. On the other hand, when the rolled paper is fed in the opposite direction of the forward direction (namely in a backward direction), the rolled paper P is fed from downstream to upstream.

The feeding mechanism 33 is provided with an inlet feeding mechanism 330, an outlet feeding mechanism 331, a first pinching mechanism 332, and a second pinching mechanism 333. The feeding mechanism 33 feeds the rolled paper P in the forward direction and in the backward direction.

The inlet feeding mechanism 330 is provided with an infeed roller 334, a motor 335, and a motor driver 336. The inlet feeding mechanism 330 is disposed on the inlet side of the printing apparatus 2, and feeds the rolled paper P in the forward direction and in the backward direction.

The infeed roller 334 cooperates with the later-described first pinching mechanism 332 in pinching the rolled paper P, and is rotatably driven by the motor 335. Thus, the direction in which the infeed roller 334 feeds the rolled paper P is determined by the direction of rotation of the motor 335, and the feeding distance of the rolled paper P is determined by the amount of rotation of the motor 335.

The motor 335, a so-called stepping motor, is rotatable in both of the forward direction and the backward direction, and the amount of rotation thereof is controllable in response to the number of control pulses. The motor driver 336 drives the motor 335. That is, the motor driver 336 controls the direction of rotation and the amount of rotation of the motor 335, in response to a control pulse signal from the controller 30.

The outlet feeding mechanism 331 is provided with an outfeed roller 337, a motor 338, and a motor driver 339. The outlet feeding mechanism 331 is disposed on the outlet side of the printing apparatus 2, and feeds the rolled paper P in the forward direction and in the backward direction.

The outfeed roller 337 cooperates with the later-described second pinching mechanism 333 in pinching the rolled paper P, and is rotatably driven by the motor 338. The direction in which the outfeed roller 337 feeds the rolled paper P is determined by the direction of rotation of the motor 338, and the feeding distance of the rolled paper P is determined by the amount of rotation of the motor 338.

The motor 338 is the same as the motor 335, except for being driven by the motor driver 339, and therefore the description thereof is omitted here.

Each of the first and second pinching mechanisms 332 and 333 consists of a pair of nip rollers. The first pinching mechanism 332 is disposed on the inlet side of the printing apparatus 2, and pinches the rolled paper P on the inlet side of the printing apparatus 2 by pressing the rolled paper P against the infeed roller 334. The second pinching mechanism 333 is disposed on the outlet side of the printing apparatus 2, and pinches the rolled paper P on the outlet side of the printing apparatus 2 by pressing the rolled paper P against the outfeed roller 337.

Although details are left out of the drawing, the first and second pinching mechanisms 332 and 333 are connected to the controller 30. In response to a control signal from the controller 30, the first and second pinching mechanisms 332 and 333 can be switched between a state of pinching the rolled paper P and a state of releasing the rolled paper P, by a driving mechanism (not shown).

The feeding device 3 is further provided with a tension measuring mechanism 34, an inlet side guide roller 35, an outlet side guide roller 36, a driving motor 37, a pair of slack sensors 38a and 38b, and a plurality of feeding rollers 39.

The tension measuring mechanism 34 is provided with a tension sensor 340 and a tension meter 341, and is disposed between the first pinching mechanism 332 (the inlet feeding mechanism 330) and the second pinching mechanism 333 (the outlet feeding mechanism 331), as shown in FIG. 1. That is, the tension measuring mechanism 34 measures tension on the rolled paper P in the printing apparatus 2. Unless otherwise noted, the term “tension” denotes the tension in a direction along the direction of feeding of the rolled paper P, though the rolled paper P is under tension in various directions.

The tension sensor 340 has a strain gauge (not shown). The force applied from the rolled paper P to the tension sensor 340 changes depending on the tension on the rolled paper P. The strain gauge of the tension sensor 340 generates an electrical signal based on the strain that changes depending on the force applied to the tension sensor 340.

In the present preferred embodiment, as shown in FIG. 1, the rolled paper P is wound around the roller of the tension sensor 340, and this roller is lifted when the tension on the rolled paper P is increased. On the other hand, the roller descends by the urging force of a spring (not shown) when the tension on the rolled paper P is decreased.

The tension sensor 340 outputs the electrical signal generated by the strain gauge of the tension sensor 340, as an output signal, to a tension meter 341. Based on the electrical signal from the tension sensor 340, the tension meter 341 measures (determines) the tension on the rolled paper P, and transmits the measurement result to the controller 30. The timing the tension meter 341 measures the tension on the rolled paper P is controlled by the controller 30.

Thus, the tension measuring mechanism 34 measures the tension on the rolled paper P between the first pinching mechanism 332 (the inlet feeding mechanism 330) and the second pinching mechanism 333 (the outlet feeding mechanism 331). Hence, the controller 30 can detect the tension on the rolled paper P in the printing apparatus 2, through the tension measuring mechanism 34.

The inlet side guide roller 35 and the outlet side guide roller 36 are members having nearly the same shape, and are disposed at different positions. The inlet side guide roller 35 is positioned upstream of the printing apparatus 2, and guides the position of the rolled paper P in a direction orthogonal to the direction of feeding of the rolled paper P (in the Y-axis direction), to a predetermined position. The outlet side guide roller 36 is positioned downstream of the printing apparatus 2, and guides the position of the rolled paper P to such a position, to which the inlet side guide roller 35 guides.

Specifically, the inlet side guide roller 35 and the outlet side guide roller 36 have the function of correcting (positioning) both ends in the Y-axis direction of the rolled paper P to substantially the same position. The position in the Y-axis direction, to which the inlet and outlet side guide rollers 35 and 36 guide the rolled paper P, is set as a position suitable for the printing process in the printing apparatus 2. In order to achieve this function, the locations (particularly, the position in the Y-axis direction) of the inlet and outlet side guide rollers 35 and 36 are determined precisely.

The driving motor 37 is drivingly controlled by the controller 30, and its driving force is transmitted to the outlet side guide roller 36 by a link member (not shown). By the driving force transmitted from the driving motor 37, the outlet side guide roller 36 is shifted between a position set on a feeding path of the rolled paper P (the position indicated in FIG. 1, hereinafter referred to as a “guide position”) and a position withdrawn from the feeding path of the rolled paper P (hereinafter referred to as a “withdrawal position”). That is, the driving motor 37 corresponds mainly to a withdrawing element in the present invention.

Thus, when the driving motor 37 shifts the outlet side guide roller 36 to the withdrawal position, the rolled paper P is brought to a state in which it is not restricted in the movement of the Y-axis direction, on the outlet side of the printing apparatus 2. On the other hand, when the driving motor 37 causes the outlet side guide roller 36 to move to the guide position, the rolled paper P is brought to a state in which its movement is restricted in the Y-axis direction, on the outlet side of the printing apparatus 2. That is, the outlet side guide roller 36 exhibits the function of positioning the rolled paper P only when it is in the guide position.

The pair of the slack sensors 38a and 38b detect the presence or absence of the rolled paper P, at their respective positions, and transmit the detection results to the controller 30. Each of the slack sensors 38a and 38b is arranged so as to detect the rolled paper P at a predetermined position of the rolled paper P that is hung by slack, and detects the rolled paper P when there is slack of not less than a predetermined amount. Specifically, the slack sensor 38a detects slack of not less than a predetermined amount L1, and the slack sensor 38b detects slack of not less than a predetermined amount L2.

The controller 30 judges whether or not adequate slack is provided in the rolled paper P, based on the detection results of the slack sensors 38a and 38b. For example, optical sensors that irradiate laser beam to a predetermined position may be used as the slack sensors 38a and 38b.

The plurality of the feeding rollers 39 feed the rolled paper P at their respective positions. Although three feeding rollers 39 are shown in FIG. 1, the number of the feeding rollers 39, of course, should not be limited to three in number.

The foregoing discussed the construction and function of the recording system 1 in the preferred embodiment. The following is the operation of the recording system 1.

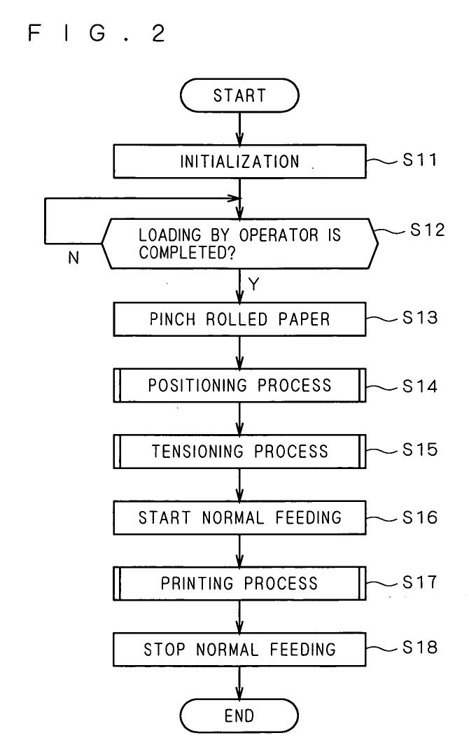

FIG. 2 is a flow chart showing mainly the operation of the feeding device 3 in the recording system 1. The recording system 1 performs a predetermined initialization (step S11), and stands by until an operator completes loading of a rolled paper P (step S12).

In the actual recording system 1, the processes in the steps S12 to S15 will be performed only when the judgment result in the initialization in step S1 is the absence of the rolled paper P. Alternatively, the presence or absence of the rolled paper P is always monitored, and the processes in the steps S12 to S15 will be performed at the point the rolled paper P is exhausted.

During the time the recording system 1 stands by based on the judgment result of “No” in step S12, the operator pulls the rolled paper P from the supplying unit 31, while holding the tip of the rolled paper P, and loads the rolled paper P along the feeding path up to the winding unit 32. At this time, the outlet side guide roller 36 is shifted to the guide position.

When the operator completes the loading, the operator then inputs data indicating the completion of the loading operation into the recording system 1 by operating an operation part (not shown).

Upon this input, the controller 30 of the feeding device 3 judges as to be “Yes” in step S12, and directs the first and second pinching mechanisms 332 and 333 to pinch the loaded rolled paper P (step S113), so that the rolled paper P is pinched on the upstream side and the downstream side of the printing apparatus 2.

Next, the recording system 1 performs the positioning process in the feeding device 3 (step S14).

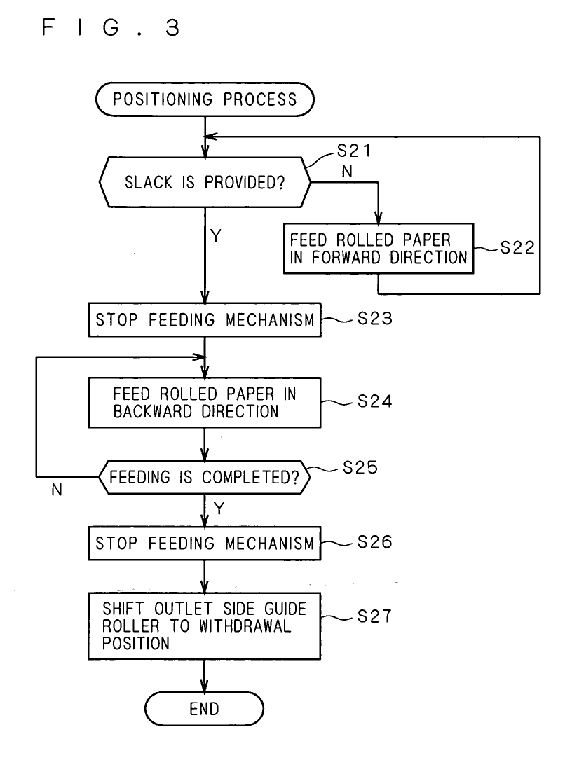

FIG. 3 is a flow chart illustrating the operation of a positioning process in the feeding device 3. In the positioning process, firstly, the slack sensor 38a located on the downstream side detects the rolled paper P, and the controller 30 judges whether or not slack of a predetermined amount L1 is provided downstream of the outlet side guide roller 36 (step S21).

When the slack of the predetermined amount L1 is provided at the corresponding position, the controller 30 skips the process in the step S22, and executes the process in step S23. For example, the process of the step S22 is not executed in a case where, when loading the rolled paper P, the operator provides in advance slack of not less than the predetermined amount L1 on the downstream side of the outlet side guide roller 36.

On the other hand, when no slack of not less than the predetermined amount L1 is provided at the corresponding position, the controller 30 directs the feeding mechanism 33 to start a forward feeding of the rolled paper P (step S22). Specifically, the inlet feeding mechanism 330 and the outlet feeding mechanism 331 are driven in the forward direction so as to feed the rolled paper P. The feeding of the rolled paper P performed in the step S22 is hereinafter referred to as a “preliminary feeding” with the feeding device 3.

The controller 30 controls the winding unit 32 so as not to wind the rolled paper P during the preliminary feeding. Hence, the rolled paper P fed by the preliminary feeding is stored downstream of the outlet side guide roller 36, and slack will be provided gradually. That is, the space on the downstream side of the outlet side guide roller 36 corresponds mainly to a storing element in the present invention, and the step S22 corresponds mainly to a storing step in the present invention.

During the preliminary feeding, the controller 30 directs the feeding mechanism 33 to continue the preliminary feeding of the rolled paper P, while monitoring the amount of slack in the rolled paper P, based on the detection of the rolled paper P through the slack sensor 38a (step S21).

Thus, the recording system 1 of the preferred embodiment is capable of automatically providing slack of an adequate amount (the predetermined amount L1) on the downstream side of the outlet side guide roller 36, even if the operator does not provide slack in the rolled paper P in advance. This eases the burden imposed on the operator who loads manually the rolled paper P.

In the conventional apparatus, the process corresponding to the preliminary feeding used to perform the lateral positioning of a recording medium. Also in the recording system 1 of the preferred embodiment, because the rolled paper P under the preliminary feeding passes through the inlet side guide roller 35, a certain degree of positioning may be given, but substantial positioning is handled in a later-described process.

If judged as to be “Yes” in step S21, the controller 30 brings the feeding mechanism 33 to the stopped state (step S23). This completes the preliminary feeding.

Thus, on termination of the step S23, the exact amount of slack is provided downstream of the outlet side guide roller 36 by the operator or the feeding mechanism 33. If the step S22 is unexecuted, the feeding mechanism 33 remains stopped, and therefore the step S23 may be skipped.

The controller 30 then controls the feeding mechanism 33 to feed the rolled paper P in a backward direction (step S24). The backward feeding of the rolled paper P (step S24) is continued until the feeding of a predetermined amount L3 of the rolled paper P is completed (step S25). The feeding of the rolled paper P performed in the steps S24 and S25 is hereinafter referred to as a “backward feeding.”

The feeding device 3 of the preferred embodiment performs positioning of the rolled paper P by the backward feeding. In order to achieve the positioning of the rolled paper P, the backward feeding of the rolled paper P is continued until a portion of the rolled paper P on the transport path, which is located at the outlet side guide roller 36 and has already been positioned by the outlet guide roller 36 when the backward feeding is started, passes through the inlet side guide roller 35. In other words, the rolled paper P loaded between the inlet side guide roller 35 and the outlet side guide roller 36 when the positioning of the rolled paper P is terminated, is entirely required to be passed through the outlet side guide roller 36 by the backward feeding.

It is therefore required that the amount of the rolled paper P fed in the backward feeding (a predetermined amount L3) is at least an amount equivalent to the distance of the feeding path between the inlet side guide roller 35 and the outlet side guide roller 36. In the feeding device 3, the predetermined amount L3 is preset so as to satisfy the expression: L3≦L4, wherein L4 is the above-mentioned least amount. As to whether or not the feeding of the predetermined amount L3 is completed, it can be judged, for example, by the time interval during which the controller 30 directs the feeding mechanism 33 to drive at a predetermined speed.

Since the predetermined amount L3 is so determined, the backward feeding of the rolled paper P of the predetermined amount L3 results in that the whole of the rolled paper P extending on the feeding path between the inlet side guide roller 35 and the outlet side guide roller 36 passed through the outlet side guide roller 36. That is, the feeding device 3 of the preferred embodiment is able to perform positioning of the rolled paper P by means of the backward feeding.

In order to feed backward the rolled paper P of the predetermined amount L3 by the backward feeding, it is required that the rolled paper P of not less than the predetermined amount L3 ready for the backward feeding be stored in advance on the downstream side. Some of the rolled paper P located downstream of the outlet side guide roller 36, the amount of which is equivalent to the length of the feeding path on the downstream side of the outlet side guide roller 36, is beyond the range of the backward feeding. On the other hand, some of the rolled paper P corresponding to slack is so-called excess, and hence it can be fed by the backward feeding.

In the feeding device 3, slack of the predetermined amount L1 is provided downstream of the outlet side guide roller 36 when the backward feeding is started (after performing the step S23). Therefore, at the time of the start of the backward feeding, it is assured that the rolled paper P of the predetermined amount L is ready for the backward feeding.

For this reason, in the feeding device 3, the predetermined amount L1 is preset so as to satisfy the expression: L1≧L3, and the slack sensor 38a is disposed so as to detect the presence of the predetermined amount L1. Accordingly, the feeding of the rolled paper P of the predetermined amount L3 is assured by the backward feeding after being judged as to be “Yes” in the step S21. That is, the backward feeding of the rolled paper P in an amount more than an excessive rolled paper P protects breakage of the rolled paper P.

If the operator loads manually the rolled paper P, it is impossible to load the rolled paper P being fixed in the Y-axis direction (So-called “movement of the hands” or the like may occur.). Therefore, in the rolled paper P loaded by the operator, the position in the Y-axis direction is defined adequately only at the position of the inlet side guide roller 35 and the position of the outlet side guide roller 36, but the position in the Y-axis direction is not assured at the other positions on the feeding path. That is, the rolled paper P at the time of performing the step S14 does not completely follow the feeding path, and meanders somewhat.

If so, by the backward feeding with the feeding device 3 as above described, the whole of the rolled paper P extending on the feeding path between the inlet side guide roller 35 and the outlet side guide roller 36 can pass through the outlet side guide roller 36. In the feeding device 3, the members other than the inlet and outlet side guide rollers 35 and 36 hardly exert the force in the Y-axis direction with respect to the rolled paper P. Consequently, the rolled paper P after passing through the outlet side guide roller 36 results in that its position in the Y-axis direction is guided to a predetermined position. That is, the backward feeding with the feeding device 3 achieves the positioning in the Y-axis direction of the rolled paper P in its initial state (namely the positioning of the rolled paper P with respect to the printing apparatus 2).

Meanwhile, with the technique of guiding the rolled paper P to a predetermined position by having the rolled paper P follow guide members such as the inlet and outlet side guide rollers 35 and 36, the tension on the rolled paper P hinders the lateral movement of the rolled paper P. Specifically, if the rolled paper P is strongly stretched between the outlet side guide roller 36 and the winding unit 32, the rolled paper P passing through the outlet side guide roller 36 by the backward feeding is not smoothly guided, so that the positioning of the rolled paper P takes much time. Further, in such a case, the outlet side guide roller 36 and the side ends of the rolled paper P will rub against each other, so that the rolled paper P might be damaged.

In the feeding device 3, however, slack of the predetermined amount L1 is provided in the roller paper P on the inlet side of the outlet side guide roller 36 (more specifically, on the inlet side at the time of the backward feeding). Further, as above described, under conditions where L1≧L3, there is no fear that this slack disappears completely during the backward feeding. Therefore, during the backward feeding, the movement in the Y-axis direction of the rolled paper P is relatively free, so that the feeding device 3 can smoothly guide the position in the Y-axis direction of the rolled paper P to a predetermined position, and can suppress breakage of the rolled paper P.

In other words, the backward feeding can be said to be a process in which the rolled paper P temporarily located downstream of the printing apparatus 2 is recovered onto the upstream side of the printing apparatus 2, by the preliminary feeding (or by the slack provided by the operator). Hence, the backward feeding with the feeding device 3 permits a reduction of the rolled paper P to be wasted in positioning the rolled paper P by the amount of the predetermined amount L3. As described above, the predetermined amount L3 is set to satisfy the expression: L1≧L3. In order to improve the rate of recovery of the rolled paper P, a larger value of the predetermined amount L3 is more preferable.

In order to reduce the amount of waste rolled paper P, it is preferable that, on termination of the backward feeding, no slack is provided downstream of the outlet side guide roller 36. That is, it is preferable to perform the backward feeding of rolled paper P corresponding to the amount of slack.

In a case where the operator loads the rolled paper P, however, it is uncertain how much slack is provided downstream of the outlet side guide roller 36. For example, if controlled so as to feed a given amount of rolled paper P in the preliminary feeding, it is uncertain how much rolled paper P becomes excess on the downstream side of the outlet side guide roller 36. That is, the amount of rolled paper P that should be supplied for the backward feeding is uncertain.

In the preferred embodiment, however, the preliminary feeding is stopped by the presence of slack of the predetermined amount L1 on the downstream side of the outlet side guide roller 36, so that the amount of excessive rolled paper P extending downstream of the outlet side guide roller 36 is the predetermined amount L1. Hence, the execution of the preliminary feeding permits determination of the exact amount of rolled paper P to be recovered by the backward feeding. This prevents an excessive rolled paper P from remaining downstream of the outlet side guide roller 36, thus suppressing a waste of the rolled paper P.

When the rolled paper P of the predetermined amount L3 is fed by the backward feeding, the controller 30 judges as to be “Yes” in the step S25, and then stops the feeding mechanism 33 (step S26). Further, the controller 30 controls the driving motor 37 to withdraw the outlet side guide roller 36 to the withdrawal position (step S27), and terminates the positioning process and then returns to the process as shown in FIG. 2.

When the printing apparatus 2 starts a printing process and the feeding device 3 starts a normal feeding, the inlet side guide roller 35 performs the positioning of the rolled paper P, without requiring the outlet side guide roller 36.

The position of the rolled paper P might be varied slightly depending on operating conditions (e.g., humidity, feeding vibration, etc.). Therefore, even if the inlet and outlet side guide rollers 35 and 36 are set so as to guide the rolled paper P to substantially the same position, the rolled paper P positioned by the inlet side guide roller 35 may wear on its ends after passing through the outlet side guide roller 36.

However, in the feeding device 3 of the preferred embodiment, on termination of the positioning step (step S14), the step S27 will be executed to withdraw the outlet side guide roller 36 to the withdrawal position. This protects breakage of the rolled paper P in the subsequent normal feeding.

On termination of the positioning process in the step S14, the recording system 1 executes a tensioning process (step S15).

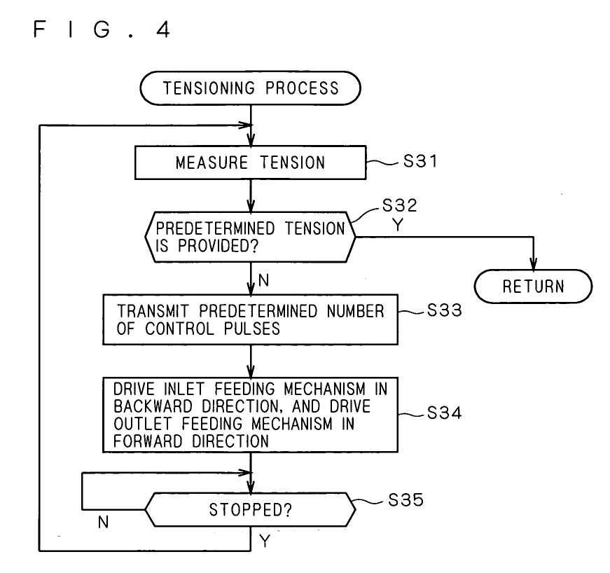

FIG. 4 is a flow chart illustrating the tensioning process in the feeding device 3. In the tensioning process, firstly, the tension measuring mechanism 34 measures the tension on the rolled paper P in the printing apparatus 2 (step S31). Specifically, the tension sensor 340 outputs an electrical signal of the strain gauge to the tension meter 341. In response to the electrical signal, the tension meter 341 measures tension and transmits it to the controller 30.

At that time, the step S26 is already executed, and the feeding mechanism 33 is stopped. That is, the tension measuring mechanism 34 measures the tension on the rolled paper P in its nearly stationary state. This enables the feeding device 3 to exactly measure the tension on the rolled paper P.

Based on the measured value, the controller 30 judges whether or not the rolled paper P is under predetermined tension (step S32). If the rolled paper P is under predetermined tension, no further increase of tension is needed. The controller 30 terminates the tensioning process and returns to the process as shown in FIG. 2.

On the other hand, when the rolled paper P is not under predetermined tension, a predetermined number (N1) of control pulses for driving the inlet feeding mechanism 330 in a backward direction are generated and transmitted to the motor driver 336, and also a predetermined number (N2) of control pulses for driving the outlet feeding mechanism 331 in a forward direction are generated and transmitted to the motor driver 339 (step S33).

In the preferred embodiment, the numbers of control pulses (N1, N2) to be transmitted to the motor drivers 336 and 339, respectively, are set to a relatively small value (about several pulses). This enables the inlet feeding mechanism 330 and the outlet feeding mechanism 331 to feed a small amount of rolled paper P.

The motor driver 336 drives the motor 335 in the backward direction by the amount of N1 control pulses, and the motor driver 339 drives the motor 338 in the forward direction by the amount of N2 control pulses (step S34).

When the step S34 goes into execution, the inlet feeding mechanism 330 feeds a small amount of the rolled paper P in the backward direction, and the outlet feeding mechanism 331 feeds a small amount of the rolled paper P in the forward direction. As a result, the rolled paper P is pulled slightly along the direction of feeding, thereby increasing little by little the amount of tension on the rolled paper P extending between the inlet feeding mechanism 330 and the outlet feeding mechanism 331.

The controller 30 stands by until the feeding mechanism 33 comes to a stop (step S35), and when it is stopped, returns to the step S31 and repeats the process.

Specifically, the execution of the step S35 enables the feeding device 3 to measure the tension on the rolled paper P in its nearly stationary state (Namely, the step S31 is executable.). This permits accurate measurement of tension on the rolled paper P.

Compared with the case of measuring while increasing tension, the tension on the rolled paper P is increased stepwise little by little, while driving the motors 335 and 338 by the amount of several pulses. This enables the tension to be controlled easily and accurately. Hence, the feeding device 3 protects breakage of the rolled paper P due to, for example, a rapid increase in the tension on the rolled paper P.

Every time when the steps S33 to S35 are repeated, the tension on the rolled paper P is increased stepwise little by little. Consequently, the rolled paper P will be under predetermined tension, and the controller 30 will judge as to be “Yes” in the step S32. If the controller 30 judges as to be “Yes” in the step S32, it terminates the tensioning process and returns to the process as shown in FIG. 2.

Thus, in the recording system 1, the positioning process in the step S14 achieves adequate positioning of the rolled paper P with respect to the printing apparatus 2, and the tensioning process in the step S15 achieves adequate providing of tension on the rolled paper P with respect to the printing apparatus 2. It is therefore possible to adequately adjust the initial state of the rolled paper P.

Returning to FIG. 2, when the tensioning process (step S15) is terminated, the feeding device 3 starts the normal feeding (step S16), and executes printing process (step S17). When the printing process is terminated, the normal feeding is stopped (step S18), and the process is terminated.

For the sake of convenience, FIG. 2 illustrates that the rolled paper P is fed continuously from the execution of the step S16 to the termination of the step S18. In fact, the rolled paper P is fed in response to the consumption of the rolled paper P in the printing process. For example, when the printing apparatus 2 performs a page printing, the rolled paper P is fed intermittently by the amount of a length corresponding to a page.

Although details are not shown in FIG. 2, before the step S16 is started, the supplying unit 31 feeds the rolled paper P of the predetermined amount L2 in a forward direction so that slack of the predetermined amount L2 is provided upstream of the inlet side guide roller 35. The controller 30 starts the step S16 after detecting the presence of the slack of the predetermined amount L2 through the upstream side slack sensor 38b. Thus, at the time of the normal feeding, the inlet side guide roller 35 of the feeding device 3 is capable of smoothly guiding the rolled paper P to a predetermined position.

As discussed above, the recording system 1 of the preferred embodiment is provided with the printing apparatus 2 that performs printing onto the lengthy rolled paper P, and the feeding device 3 that feeds the rolled paper P in the forward direction. The feeding device 3 measures the tension on the rolled paper P every time the tension is increased, and the tension on the rolled paper P is further increased stepwise little by little until the measured value is not less than a predetermined value. Compared with the case of controlling while continuously increasing the tension on the rolled paper P, the tension can be controlled with higher accuracy. This protects, for example, against breakage of the rolled paper P.

Further in the recording system 1, by the backward feeding of the rolled paper P stored in advance, at least part of the rolled paper P, which is guided to a predetermined position in the Y-axis direction (the lateral direction) by the outlet side guide roller 36, can be fed to the inlet side guide roller 35 by the feeding mechanism 33. Therefore, the lateral positioning requires no forward auxiliary run, preventing a waste of the rolled paper P.

With the construction of the foregoing preferred embodiment, the both ends of the rolled paper P are pulled when the tension on the rolled paper P is increased little by little. This method is however cited merely by way of example and without limitation. The followings are methods other than this.

In an alternative, in the process corresponding to the step S33 in FIG. 4, the controller 30 transmits the N2 control pulses only to the outlet feeding mechanism 331, and transmits no control pulses for driving to the inlet feeding mechanism 330. Under this control, in the process corresponding to the step S34, the upstream end of the rolled paper P is stopped by the first pinching mechanism 332, and only the outlet feeding mechanism 331 is driven in the forward direction.

This brings the rolled paper P to a state in which it is pulled from the outlet side, so that tension increases little by little. That is, this alternative method also produces the same effect as in the foregoing preferred embodiment.

In another alternative, in the process corresponding to the step S33 in FIG. 4, the controller 30 transmits the N1 control pulses only to the inlet feeding mechanism 330, and transmits no control pulses for driving to the outlet feeding mechanism 331. Under this control, in the process corresponding to the step S34, the downstream end of the rolled paper P is stopped by the second pinching mechanism 333, and only the inlet feeding mechanism 330 is driven in the backward direction.

This brings the rolled paper P to a state in which it is pulled from the inlet side, so that tension increases little by little. That is, this alternative method also produces the same effect as in the foregoing preferred embodiment.

Instead of the driving motor 37 that is the mechanism for shifting the outlet side guide roller 36, a mechanism for shifting only a flange (not shown) that guides the position in the Y-axis direction of the rolled paper P in the outlet side guide roller 36 may be employed as a withdrawing element. That is, it is possible to employ any type of mechanism by which the function of the outlet side guide roller 36, namely, the function of defining the rolled paper P in the Y-axis direction, is made valid/invalid.

For the backward feeding of the rolled paper P of the predetermined amount L3, no slack may be provided throughout the rolled paper P that is stored downstream and is ready for the backward feeding. For example, a portion of the rolled paper may be wound with the winding unit 32 so as to be pulled from the winding unit 32 at the time of the backward feeding. That is, the winding unit 32 may form part of the storing element.

While the invention has been shown and described in detail, the foregoing description is in all aspects illustrative and not restrictive. It is therefore understood that numerous modifications and variations can be devised without departing from the scope of the invention.

What is claimed is:

1. A feeding device that feeds a long recording medium in a forward direction with respect to a recording device, comprising:
a measuring element that measures tension on the recording medium in the recording device;
a tensioning element that stepwise increases little by little tension on the recording medium in the recording device; and
a control element that directs the measuring element to measure tension on the recording medium every time the tensioning element produces an increase in tension, and that directs the tensioning element to further increase the tension on the recording medium until the tension on the recording medium measured by the measuring element is not less than a predetermined value.

2. The feeding device according to claim 1, further comprising:
an outlet feeding element that feeds the recording medium in the forward direction on an outlet side of the recording device; and
a first pinching element that pinches the recording medium on an inlet side of the recording device,
wherein,
the tensioning element stepwise increases little by little tension on the recording medium by controlling the outlet feeding element so as to feed a small amount of the recording medium, while allowing the first pinching element to pinch and stop the recording medium.

3. The feeding device according to claim 1, further comprising:
an inlet feeding element that feeds the recording medium in an opposite direction of the forward direction on the inlet side of the recording device; and
a second pinching element that pinches the recording medium on the outlet side of the recording device,
wherein,
the tensioning element stepwise increases little by little tension on the recording medium by controlling the inlet feeding element so as to feed a small amount of the recording medium in the opposite direction, while allowing the second pinching element to pinch and stop the recording medium.

4. The feeding device according to claim 1, further comprising:
an inlet feeding element that feeds the recording medium in an opposite direction of the forward direction on the inlet side of the recording device; and
an outlet feeding element that feeds the recording medium in the forward direction on the outlet side of the recording device,
wherein,
the tensioning element stepwise increases little by little tension on the recording medium by controlling the inlet feeding element so as to feed a small amount of the recording medium in the opposite direction, and controlling the outlet feeding element so as to feed a small amount of the recording medium in the forward direction.

5. The feeding device according to claim 1 wherein,
the measuring element measures tension on the recording medium with the recording medium being substantially at rest.

6. A recording system that records information in a long recording medium, comprising:
a recording device that records information on the recording medium; and
a feeding device that feeds the recording medium in a forward direction with respect to the recording device,
the feeding device comprising:
a measuring element that measures tension on the recording medium in the recording device;
a tensioning element that stepwise increases little by little tension on the recording medium in the recording device; and
a control element that directs the measuring element to measure tension on the recording medium every time the tensioning element produces an increase in tension, and that directs the tensioning element to further increase the tension on the recording medium until the tension on the recording medium measured by the measuring element is not less than a predetermined value.

7. A feeding method for feeding a long recording medium in a forward direction with respect to a recording device, comprising the steps of:
a measuring step of measuring tension on the recording medium in the recording device;
a tensioning step of stepwise increasing little by little tension on the recording medium in the recording device; and
a control step of repeating the tensioning step until the tension on the recording medium is not less than a predetermined value, while allowing for measurement of tension on the recording medium in the measuring step every time the tensioning step is executed to increase the tension on the recording medium.

8. A feeding device that feeds a long recording medium in a forward direction with respect to a recording device, comprising:
a feeding element that feeds the recording medium in the forward direction and in an opposite direction of the forward direction;
an inlet side guiding element that is disposed on an inlet side of the recording device, and guides a position of the recording medium in a lateral direction orthogonal to the forward direction, to a predetermined position;
an outlet side guiding element that is disposed on an outlet side of the recording device, and guides a position of the recording medium in the lateral direction, to substantially the same position as the inlet side guiding element;
a storing element that is disposed on a downstream side with respect to the forward direction of the outlet side guiding element, and stores in advance the recording medium of not less than a predetermined amount feedable in the opposite direction; and
a control element that controls a feed of the recording medium performed by the feeding element,
wherein,
the control element controls so that at least part of the recording medium guided by the outlet side guiding element to the predetermined position in the lateral direction is fed to the inlet side guide element, by allowing the recording medium stored in the storing element by the storing element to be fed in the opposite direction.

9. The feeding device according to claim 8 wherein,
the control element controls so that a recording medium of not less than a predetermined amount feedable in the opposite direction is stored in advance in the storing element, by directing the feeding element to feed in the forward direction the recording medium of not less than the predetermined amount.

10. The feeding device according to claim 8, further comprising:
a winding unit that winds a recording medium and is disposed on a downstream side with respect to the forward direction of the outlet side guiding element,
wherein,
slack is provided on the recording medium between the outlet side guiding element and the winding unit.

11. The feeding device according to claim 8, further comprising:
a supplying unit that supplies a recording medium to the inlet side guide element,
wherein,
slack is provided on the recording medium between the inlet side guiding element and the supplying unit.

12. The feeding device according to claim 8, further comprising:
a withdrawing element that withdraws the outlet side guiding element.

13. A recording system that records information in a long recording medium, comprising:
a recording device that records information on the recording medium; and
a feeding device that feeds the recording medium in a forward direction to the recording device,
the feeding device comprising:
a feeding element that feeds the recording medium in the forward direction and an opposite direction of the forward direction;
an inlet side guiding element that is disposed on an inlet side of the recording device, and guides a position of the recording medium in a lateral direction orthogonal to the forward direction to a predetermined position;
an outlet side guiding element that is disposed on an outlet side of the recording device, and guides a position of the recording medium in the lateral direction to substantially the same position as the inlet side guiding element;
a storing element that is disposed on a downstream side with respect to the forward direction of the outlet side guiding element, and stores in advance a recording medium of not less than a predetermined amount feedable in the opposite direction; and
a control element that controls a feed of the recording medium performed by the feeding element,
wherein,
the control element controls so that at least part of the recording medium guided by the outlet side guiding element to the predetermined position in the lateral direction is fed to the inlet side guide element, by allowing the recording medium stored in the storing element by the storing element to be fed in the opposite direction.

14. A feeding method for feeding a long recording medium in a forward direction to a recording device, comprising the steps of:
a storing step of storing in advance a recording medium of not less than a predetermined amount feedable in an opposite direction of the forward direction, in a storing element disposed on an outlet side of the recording device; and
a backward feeding step of feeding at least part of a recording medium guided by an outlet side guiding element to a predetermined position in a lateral direction orthogonal to the forward direction, to an inlet side guiding element, by feeding the recording medium stored in the storing element in the opposite direction,
wherein,
the outlet side guiding element is disposed between the storing element and the outlet side of the recording device, and the inlet side guiding element is disposed on an inlet side of the recording device, and guides a position of the recording medium in the lateral direction to substantially the same position as the outlet side guiding element.
